(19) United States
(12) Patent Application Publication
(10) Pub. No.: US 2020/0019641 A1
(43) Pub. Date: Jan. 16, 2020

(54) RESPONDING TO MULTI-INTENT USER INPUT TO A DIALOG SYSTEM

(71) Applicant: INTERNATIONAL BUSINESS MACHINES CORPORATION, ARMONK, NY (US)

(72) Inventors: Alexander C. Tonetti, Washington, DC (US); Edward G. Katz, Washington, DC (US); Sean T. Thatcher, Stone Ridge, VA (US); JOHN RIENDEAU, Madison, WI (US)

(21) Appl. No.: 16/032,026

(22) Filed: Jul. 10, 2018

(51) Int. Cl. G06F 17/30; G10L 15/22; G10L 13/06; G10L 15/08

(52) U.S. Cl. CPC G06F 17/30654; G10L 15/22; G10L 2015/225; G10L 15/08; G10L 13/06

(57) ABSTRACT

A dialog system receives a multi-intent input from a user, wherein the multi-intent input comprises a selection of multiple intents in a single conversational input. The dialog system splits the multi-intent input into multiple segments, wherein each of the segments comprises a subsequence of the multi-intent input. The dialog system applies a classifier to classify each segment of the multiple segments by at least one pair of a plurality of pairs in a matrix, each pair of a separate class of multiple classes and a separate confidence level of classification, each of the multiple classes associated with a separate intent from among the multiple intents. The dialog system selects one or more outputs for each separate class in each separate pair, in view of the separate confidence level. The dialog system outputs a response comprising a concatenation of the one or more outputs to the user.

### BACKGROUND

### 1. Technical Field

This invention relates in general to computing systems and more particularly to responding to multi-intent user input.

### 2. Description of the Related Art

Traditional dialog systems use a classifier to assign a single class to conversational user input and respond with an output selected for the single class, to mimic a human interaction.

### BRIEF SUMMARY

In one embodiment, a method is directed to receiving, by a computer, a multi-intent input from a user, wherein the multi-intent input comprises a selection of a plurality of intents in a single conversational input. The method is directed to splitting, by the computer, the multi-intent input into a plurality of segments, wherein each of the segments comprises a subsequence of the multi-intent input. The method is directed to applying, by the computer, a classifier to classify each segment of the plurality of segments by at least one pair of a plurality of pairs in a matrix, each pair of a separate class of a plurality of classes and a separate confidence level of classification, each of the plurality of classes associated with a separate intent from among the plurality of intents. The method is directed to selecting, by the computer, one or more outputs for each separate class in each separate pair, in view of the separate confidence level. The method is directed to outputting, by the computer, a response comprising a concatenation of the one or more outputs to the user.

In another embodiment, a computer system comprises one or more processors, one or more computer-readable memories, one or more computer-readable storage devices, and program instructions, stored on at least one of the one or more storage devices for execution by at least one of the one or more processors via at least one of the one or more memories. The stored program instructions comprise program instructions to receive a multi-intent input from a user, wherein the multi-intent input comprises a selection of a plurality of intents in a single conversational input. The stored program instructions comprise program instructions to split the multi-intent input into a plurality of segments, wherein each of the segments comprises a subsequence of the multi-intent input. The stored program instructions comprise program instructions to apply a classifier to classify each segment of the plurality of segments by at least one pair of a plurality of pairs in a matrix, each pair of a separate class of a plurality of classes and a separate confidence level of classification, each of the plurality of classes associated with a separate intent from among the plurality of intents. The stored program instructions comprise program instructions to select one or more outputs for each separate class in each separate pair, in view of the separate confidence level. The stored program instructions comprise program instructions to output a response comprising a concatenation of the one or more outputs to the user.

In another embodiment, a computer program product comprises a computer readable storage medium having program instructions embodied therewith, wherein the computer readable storage medium is not a transitory signal per se. The program instructions are executable by a computer to cause the computer to receive, by a computer, a multi-intent input from a user, wherein the multi-intent input comprises a selection of a plurality of intents in a single conversational input. The program instructions are executable by a computer to cause the computer to split, by the computer, the multi-intent input into a plurality of segments, wherein each of the segments comprises a subsequence of the multi-intent input. The program instructions are executable by a computer to cause the computer to apply, by the computer, a classifier to classify each segment of the plurality of segments by at least one pair of a plurality of pairs in a matrix, each pair of a separate class of a plurality of classes and a separate confidence level of classification, each of the plurality of classes associated with a separate intent from among the plurality of intents. The program instructions are executable by a computer to cause the computer to select, by the computer, one or more outputs for each separate class in each separate pair, in view of the separate confidence level. The program instructions are executable by a computer to cause the computer to output, by the computer, a response comprising a concatenation of the one or more outputs to the user.

### BRIEF DESCRIPTION OF THE SEVERAL VIEWS OF THE DRAWINGS

The novel features believed characteristic of one or more embodiments of the invention are set forth in the appended claims. The one or more embodiments of the invention itself however, will best be understood by reference to the following detailed description of an illustrative embodiment when read in conjunction with the accompanying drawings, wherein:

FIG. 1 is a block diagram illustrating one example of a classifier-based dialog system for managing a response to multi-intent user input;

FIG. 2 is a block diagram illustrating one example of a partitioning policy, applied in a dialog system for partitioning multi-intent user input, generated from training data, which is also used to train a classifier for the dialog system;

FIG. 3 is a block diagram illustrating one example of a management controller for generating a response strategy for managing responses to multi-intent user input to a dialog system;

FIG. 4 is a block diagram illustrating one example of a response generated for a multi-intent user input to a classifier-based dialog system;

FIG. 5 is a block diagram illustrating one example of a computer system in which one embodiment of the invention may be implemented;

FIG. 6 illustrates a high level logic flowchart of a process and computer program for generating a partitioning policy, applied in a dialog system for partitioning multi-intent user input, generated from training data, which is also used to train a classifier for the dialog system;

FIG. 7 illustrates a high level logic flowchart of a process and computer program for specifying a response strategy for managing responses to multi-intent user input to a dialog system; and

FIG. 8 illustrates a high level logic flowchart of a process and computer program for managing a response to a multi-intent user input by a classifier-based dialog system.

### DETAILED DESCRIPTION

In the following description, for the purposes of explanation, numerous specific details are set forth to provide a thorough understanding of the present invention. It will be apparent, however, to one skilled in the art that the present invention may be practiced without these specific details. In other instances, well-known structures and devices are shown in block diagram form to avoid unnecessarily obscuring the present invention.

In addition, in the following description, for purposes of explanation, numerous systems are described. It is important to note, and it will be apparent to one skilled in the art, that the present invention may execute in a variety of systems, including a variety of computer systems and electronic devices operating any number of different types of operating systems.

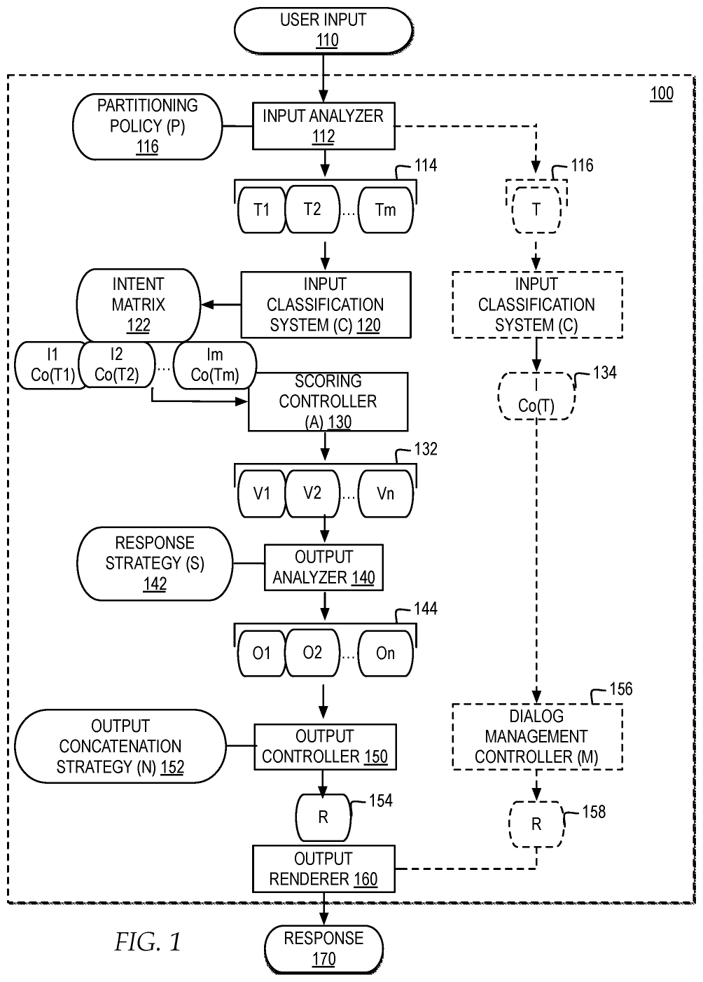

FIG. 1 illustrates a block diagram of one example of a classifier-based dialog system for managing a response to multi-intent user input.

In an embodiment, the system includes a dialog system 100 that represents a natural language interface, conversational agent, or other type of dialog system that receives unstructured user inputs in one or more formats, illustrated as user input 110, and returns a response 130. In one example, dialog system 100 represents a classifier-based dialog management system. In one example, a classifier-based dialog system classifies inputs, such as user input 100, using a trained machine-learning system, based on ideal or typical input, to determine the likely intent of the input and then generate a response, such as response 170, based on the output trained for the most likely intent. In one example, dialog system 100 recognizes user input 110 from and responds through a response 170 in one or more formats including, but not limited to, text, speech, graphic, haptics, gestures, and additional or alternate modes of communication, on both an input and output channel. In one example, user input 110 represents natural language or conversational inputs and dialog system 100 outputs response 170 in a coherent structure, to provide a computer system intended to converse, through output response 130, in a manner similar to a human responding to user input 110. For example, dialog system 100 supports one or more types of dialog with a user, including but not limited to, responding to customer service inquiries regarding a product or service, guiding purchases by customers, responding to internal queries within an organization, assisting users in navigating a website, providing technical support, providing personalized service, or training or educating the user.

In an embodiment, for recognizing and managing user input 110, dialog system 100 implements a recognizer or decoder for converting user speech into plain text through one or more of an automatic speech recognizer, a gesture recognizer, and a handwriting recognizer. In addition, in another aspect, dialog system 100 implements additional or alternate types of receivers and converters for converting user communication into a format within user input 110 that may be processed by dialog system 100.

In an embodiment, user input 110 represents unstructured input that includes one or more intents, where each intent may be classified by one or more separate classes. An advantage of one or more embodiments of the present invention is that dialog system 100 is enabled to efficiently and accurately manage classifications of multi-intent user inputs into multiple classes, rather than being limited to classifying all inputs into a single class. In particular, while traditional dialog systems may be trained and implemented with an implicit assumption that each individual user input will correspond to a single expression of intent and assign only a single class to the user input, in practice, users may provide long, conversational inputs that include multiple intents or one or more intents combined with information that is not relevant to providing an accurate response, resulting in other dialog systems that determine a single class for an input potentially misclassifying multiple intents as a single class and either failing to generate an answer to any of the intents or incorrectly answering the user input. For example, user input 110 such as “Hi, I am looking for some information about my water account. I want to know if I can shut off the water for the time I'm going to be away this summer. And, how I can get it turned back on again”, has a first intent of needing information regarding how to temporarily shut water off and a second intent of needing information regarding how to have water turned back on again. In a traditional dialog system that assumes a single intent, only one of the two intents may be classified and responded to, or an incorrect intent may be classified and responded to, the user would only receive part of the information requested, if any. In contrast, in an embodiment of the invention, dialog system 100 supports multi-intent user inputs and determines a response to each of the intents, to provide a single response that completely and accurately responds to multiple intents in a single user input.

In one example, for dialog system 100 to support efficient and accurate responses to multi-intent user inputs, dialog system 100 splits user input 110 into segments, apply a classifier to each of the segments, determine based on the classifier's output what segments of the user input should be responded to, and determine how the response should be formulated.

In one embodiment, dialog system 100 implements an input analyzer 112 to split user input 110 into segments, illustrated in a sequence 114 as “T1, T2 . . . Tm”, where each of the ‘m’ segments is a subsequence of T. In one example, each of the segments in sequence 114 may be a same length or different lengths. In one example, sequence 114 may include segments with overlapping portions of user input and sequence 114 may only include a selection of T, with irrelevant portions discarded.

In one embodiment, in splitting user input 110 into segments, input analyzer 112 applies a partitioning policy (P) 116, which specifies a strategy for splitting multi-intent inputs. In one example, partitioning policy (P) 116 is determined based on training data, which may also be used to train an input classification system (C) 120. In the example, the training data used to train input classification system (C) 120 includes one or more types of characteristics, which may be applied in partitioning policy (P) 116. For example, if a type of characteristic of a predominant portion of a corpus of training data is based on single-clause elements, such as a verb and a subject, partitioning policy (P) 116 is specified to split user input 110 into segments on the basis of clause boundaries in user input 110. In another example, if a type of characteristic of a predominant portion of a corpus of training data is based on sentences, partitioning policy (P) 116 is specified to split user input 110 into sentences or smaller chunks of n-grams or words, but likely not paragraphs. In one example, partitioning policy (P) 116 may generate a partition or a cover.

In one embodiment, dialog system 100 implements an input classification system (C) 120 to apply a classifier to each of the segments in sequence 114. In one example, input classification system (C) 120 is pre-trained, with the same corpus of training data applied to partitioning policy (P) 116, to classify words, phrases, sentences, or other textual characteristics with one or more of multiple intent classes. In one example, in classifying each of the segments in sequence 114, input classification system (C) 120 generates an intent matrix 122 of pairs of at least one intent class (I) and a confidence score (Co) for each segment in sequence 114. In one example, a confidence score (Co) represents a percentage likelihood that input classification system (C) 120 has correctly classified the intent class for a segment of user input. In one example, input classification system (C) 120 selects multiple classes for a segment, with each class identified by a separate confidence score in a pair, such as a first class with a first confidence and a second class with a second confidence.

In one embodiment, dialog system 100 implements a scoring controller (A) 130 to apply a scoring method to intent matrix 122 to return a sequence of scored intents 132 as “V1, V2, . . . Vn”, where ‘n’ may be equal to, greater than, or less than ‘m’ in sequence 114. In one example, sequence of scored intents 132 aggregates and ranks the classes and confidence levels identified in intent matrix 122, to identify one or more selected intent classes to respond to. According to one aspect of the invention, scoring controller (A) 130 prioritizes the order of intents and selects a minimum or maximum number of intents to score. In one example, in aggregating classes and confidence levels, scoring controller (A) 130 aggregates classes by combining confidence levels and by combining classes and subclass levels. For example, if a class of “pay by credit card” is a subclass of the class “pay bill”, then scoring controller (A) 130 aggregates the two classes into just the subclass.

In one embodiment, dialog system 100 implements an output analyzer 140, which applies a response strategy (S) 142 to sequence of scored intents 132 to generate a sequence of outputs 144 illustrated as “O1, O2, . . . On” based on characteristics of how the dialog should proceed as identified in response strategy (S) 142. In one example, response strategy (S) 142 dynamically specifies output characteristics for application to each intent to generate sequence of outputs 144.

In one example, dialog system 100 implements an output controller 150 to apply an output concatenation strategy (N) 152 to sequence of outputs 144 to generate a response (R) 154. In one example, output concatenation strategy (N) 152 specifies a strategy to always place an output for an intent classified as a “greeting” before other outputs within sequence of outputs 144, within response (R) 154. In another example, output concatenation strategy (N) 152 specifies a strategy for combining multiple outputs in sequence of outputs 144, such as placing transition text between one or more of the outputs in sequence of outputs 144, to generate response (R) 154.

In one embodiment, dialog system 100 implements an output renderer 160 that converts response (R) 154 into a format for output to a particular user, as response 170. For example, output renderer 160 includes a translator for converting plain text in response (R) 154 into an output format detectable by a user, through one or more of a natural language generator, text-to-speech engine, gesture generator, talking head, layout manager, robot, or avatar.

In one example, if input analyzer 112 analyzes user input 110 according to partitioning policy (P) 116 and detects only a single intent T within user input 110, illustrated at reference numeral 116, input classification system (C) 120 classifies the single intent with at least one class and confidence, I (Co(T)) as illustrated at reference numeral 134, and a dialog management controller (M) 156 may select a response (R) 158 for the classified intent. In one example, dialog management controller (M) 156 is trained to select a particular class, if multiple classes are identified for a single intent, and to select a particular response for each class.

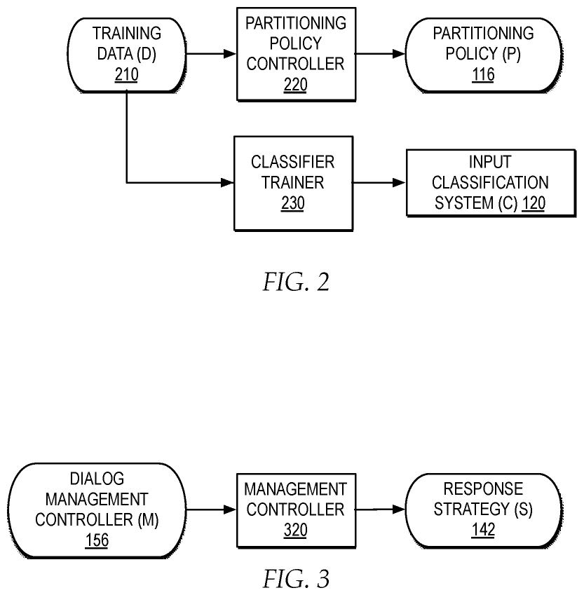

FIG. 2 illustrates a block diagram of one example of a partitioning policy, applied in a dialog system for partitioning multi-intent user input, generated from training data, which is also used to train a classifier for the dialog system.

In one embodiment, a partitioning policy controller 220 applies selections of or all of a corpus of training data (D) 210 to specify partitioning policy (P) 116, for setting one or more rules and policies for directing segmentation of user inputs. In one example, partitioning policy controller 220 identifies one or more types of characteristics of training data (D) 210, such as whether the training data is primarily composed of words, clauses, or sentences, and set partitioning policy (P) 116 to partition user input into segments based on the same type of characteristics of training data (D) 210. In addition, partitioning policy controller 220 specifies partitioning policy 116 to determine boundaries within user input based on whether the user input is originally entered as speech or text, where according to one aspect, partitioning policy 116 is specified to identify intonation phrases and other indicators translated from speech to text, in an example where the user input is originally speech. According to another aspect, partitioning policy controller 220 specifies partitioning policy 116 based on the type of user interface accessed by a user, where specific characteristics of input may be detected based on interface, such as characteristics of input detected if a user selects an avatar based interface.

In one embodiment, a classifier trainer 230 applies selections of or all of the corpus of training data (D) 210 to train input classifications system (C) 120 to classify words, sentences, phrases, or other textual segments according to one or more classes, where each class identifies an intent. In one example, classifier trainer 230 applies one or more types of training techniques to train input classification system (C) 120 and modifies training data (D) 210 to build a larger corpus of data applicable to improve the accuracy of classification by input classification system (C) 120. In one example, classifier trainer 230 trains input classifications system (C) 120 within a recurrent neural network (RNN) or other type of network and memory architecture selected for training a classification system.

FIG. 3 illustrates a block diagram of one example of a management controller for generating a response strategy for managing responses to multi-intent user input to a dialog system.

In one embodiment, a dialog management method of dialog management controller (M) 156 is applied within a dialog system to select an output in response to an intent class determined for a single-intent user input. In one example, for application in dialog system 100, which manages both multi-intent and single-intent user input, a management controller 320 applies an output management method applied by dialog management controller (M) 156 to generate response strategy (S) 142, for specifying a strategy for selecting outputs for multi-intent user input. In one example, response strategy (S) 142 is applied by output analyzer 140 of dialog system 100 to multiple weighted intents to select an output for each weighted intent and to order the sequence of outputs.

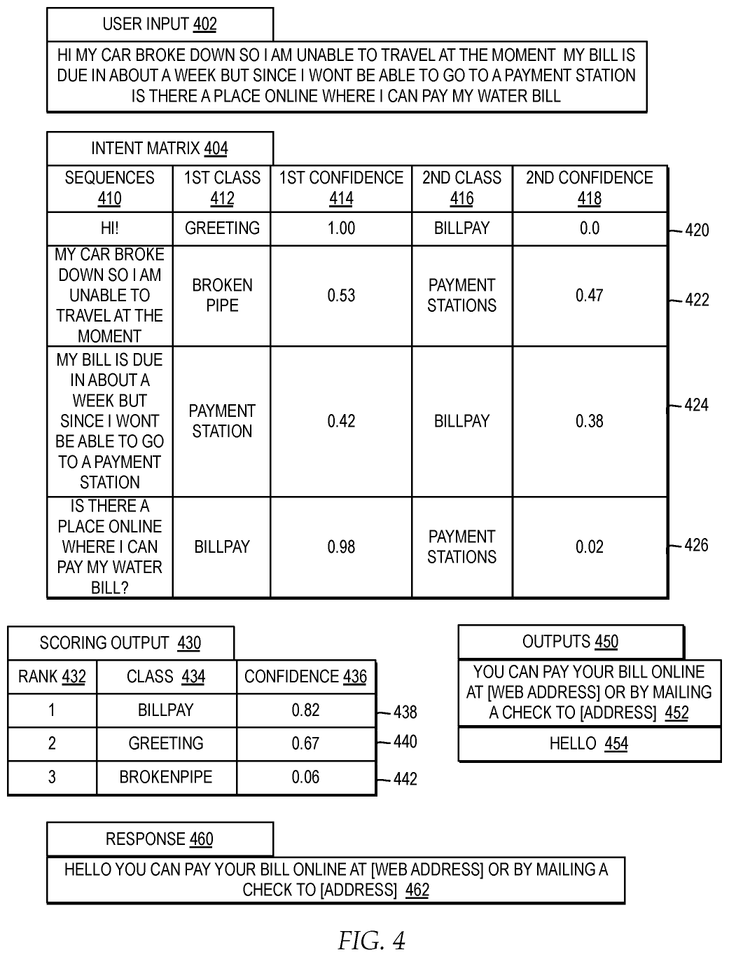

FIG. 4 illustrates a block diagram of one example of a response generated for a multi-intent user input to a classifier-based dialog system.

In one embodiment illustrated in FIG. 4, a user input 402 is illustrated as “hi my car broke down so I am unable to travel at the moment my bill is due in about a week but since I won't be able to go to a payment station is there a place online where I can pay my water bill”. In the example illustrated in FIG. 4, input analyzer 112 receives user input 402 and segment user input 402 into a sequence of segments of user input 402, with partitioning at a sentence level according to partitioning policy (P) 116, and input classification system (C) 120 generates an intent matrix 404 for the segments.

In one example illustrated in FIG. 4, intent matrix 404 illustrates one example of user input 402 partitioned at the sentence level into sequences 410, illustrates a first intent class determined for the sequence segment in 1st class 412 and a confidence of the 1st class 414, and a second intent class determined for the sequence segment in 2nd class 416 and a confidence of the 2nd class 418. As illustrated, a sequence in row 420 is “hi”, classified first as a class “greeting” with a confidence of “1.00” and classified second as a class “billpay” with a confidence of “0.0”. As illustrated, a sequence in row 422 is “my car broke down so I am unable to travel at the moment”, classified first as a class “brokenpipe” with a confidence of “0.53” and classified second as a class “paymentstations” with a confidence of “0.47”. As illustrated, a sequence in row 424 is “my bill is due in about a week but since I won't be able to go to a payment station”, classified first as a class “paymentstation” with a confidence of “0.42” and classified second as a class “billpay” with a confidence of “0.38”. As illustrated, a sequence in row 426 is “is there a place online where I can pay my water bill?”, classified first as a class “billpay” with a confidence of “0.98” and classified second as a class “paymentstations” with a confidence of “0.02”.

In one example illustrated in FIG. 4, intent matrix 404 illustrates user input 402 classified under multiple classes, indicating multiple intents. Dialog system 100 provides a classifier-based system that also handles multi-intent user input to minimize misclassification of intent classes and to increase the probability that dialog system 100 responds to all relevant intents in user input. In the example, if only a single intent other than a greeting were selected for determining an output, the class with the single highest confidence level other than “greeting” is “billpay”, with a confidence level of “0.98”. In contrast, in another example, intent matrix 404 illustrates an example in which the user input with multi-intents is first split into multiple segments and then each segment classified, to increase the probability that each intent within user input 402 is properly classified.

In one example illustrated in FIG. 4, scoring output 430 illustrates an example of scored intents 132, based on aggregated scoring of intent matrix 404 by scoring controller (A) 130. In one example, scoring output 430 illustrates aggregated and prioritized scoring identified by a rank 432, class 434, and confidence level 436. In one example, based on an evaluation of intent matrix 404, scoring controller (A) 130 ranks a class “billpay” first, with a combined confidence of “0.82” in a row 438, ranks a class “greeting” second, with a combined confidence of “0.067” in a row 440, and ranks a class “brokenpipe” third, with a combined confidence of “0.06” in a row 442. In the example, while a class of “paymentstations” is identified in intent matrix 404, scoring output 430 is generated without the class “paymentstations”.

In one example illustrated in FIG. 4, scoring output 430 reflects an aggregation and scoring of outputs based on multiple conditions, including a threshold. For example, scoring output 430 applies a threshold of 0.50 to a first confidence level, where the first confidence level of “0.42” for class “payment station” in row 424 does not meet the threshold level and therefore is not included in scoring output 510.

In one example illustrated in FIG. 4, output analyzer 140 applies response strategy (S) 142 to scoring output 430 to select one or more outputs for a response. In one example, outputs 450 includes a first output 452 selected for the class “billpay” of “you can pay our bill online at [web address] or by mailing a check to [address].” In another example, outputs 450 is dynamically updated to include a particular web address for the value “[web address]” and a particular physical address for the value “[address]”. In another example, outputs 450 includes a second output 454 for the class “greeting” of “hello”.

In one example illustrated in FIG. 4, output controller 150 generates a response 460 that is a concatenation of outputs 450. For example, as illustrated at reference numeral 462, response 460 includes a response of “hello you can pay your bill online at [web address] or by mailing a check to [address]”.

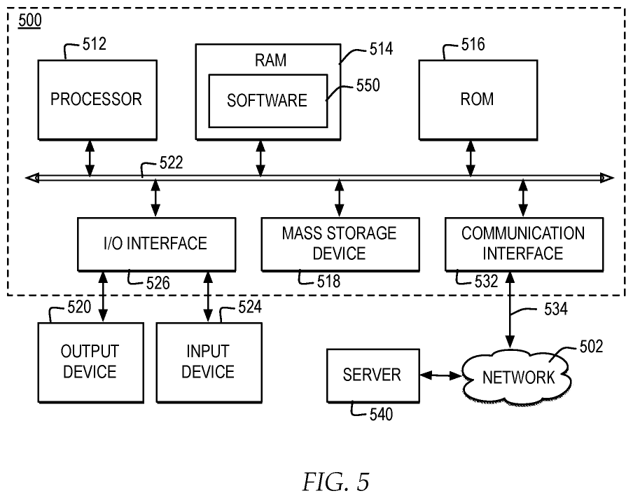

FIG. 5 illustrates a block diagram of one example of a computer system in which one embodiment of the invention may be implemented. The present invention may be performed in a variety of systems and combinations of systems, made up of functional components, such as the functional components described with reference to a computer system 500 and may be communicatively connected to a network, such as network 502.

Computer system 500 includes a bus 522 or other communication device for communicating information within computer system 500, and at least one hardware processing device, such as processor 512, coupled to bus 522 for processing information. Bus 522 preferably includes low-latency and higher latency paths that are connected by bridges and adapters and controlled within computer system 500 by multiple bus controllers. In one embodiment, when implemented as a server or node, computer system 500 includes multiple processors designed to improve network servicing power.

In one embodiment, processor 512 is at least one general-purpose processor that, during normal operation, processes data under the control of software 550, which includes at least one of application software, an operating system, middleware, and other code and computer executable programs accessible from a dynamic storage device such as random access memory (RAM) 514, a static storage device such as Read Only Memory (ROM) 516, a data storage device, such as mass storage device 518, or other data storage medium. In one embodiment, software 550 includes, but is not limited to, code, applications, protocols, interfaces, and processes for controlling one or more systems within a network including, but not limited to, an adapter, a switch, a server, a cluster system, and a grid environment.

In one embodiment, computer system 500 communicates with a remote computer, such as server 540, or a remote client. In one example, server 540 is connected to computer system 500 through any type of network, such as network 502, through a communication interface, such as network interface 532, or over a network link connected, for example, to network 502.

In one embodiment, multiple systems within a network environment are communicatively connected via network 502, which is the medium used to provide communications links between various devices and computer systems communicatively connected. Network 502 includes permanent connections such as wire or fiber optics cables and temporary connections made through telephone connections and wireless transmission connections, for example, and may include routers, switches, gateways and other hardware to enable a communication channel between the systems connected via network 502. Network 502 represents one or more of packet-switching based networks, telephony based networks, broadcast television networks, local area and wire area networks, public networks, and restricted networks.

Network 502 and the systems communicatively connected to computer 500 via network 502 implement one or more layers of one or more types of network protocol stacks which may include one or more of a physical layer, a link layer, a network layer, a transport layer, a presentation layer, and an application layer. For example, network 502 implements one or more of the Transmission Control Protocol/Internet Protocol (TCP/IP) protocol stack or an Open Systems Interconnection (OSI) protocol stack. In addition, for example, network 502 represents the worldwide collection of networks and gateways that use the TCP/IP suite of protocols to communicate with one another. Network 502 implements a secure HTTP protocol layer or other security protocol for securing communications between systems.

In the example, network interface 532 includes an adapter 534 for connecting computer system 500 to network 502 through a link and for communicatively connecting computer system 500 to server 540 or other computing systems via network 502. Although not depicted, network interface 532 may include additional software, such as device drivers, additional hardware and other controllers that enable communication. When implemented as a server, computer system 500 may include multiple communication interfaces accessible via multiple peripheral component interconnect (PCI) bus bridges connected to an input/output controller, for example. In this manner, computer system 500 allows connections to multiple clients via multiple separate ports and each port may also support multiple connections to multiple clients.

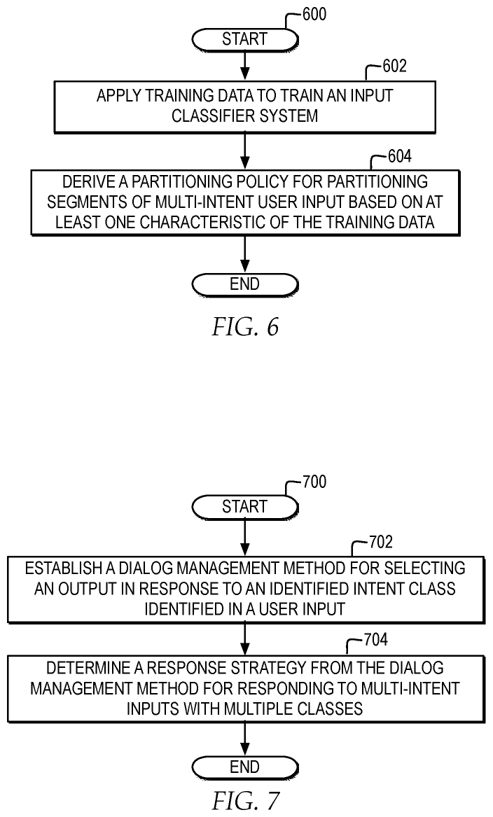

In one embodiment, the operations performed by processor 512 control the operations of flowchart of FIGS. 6-8 and other operations described herein. In one embodiment, operations performed by processor 512 are requested by software 550 or other code or the steps of one embodiment of the invention might be performed by specific hardware components that contain hardwired logic for performing the steps, or by any combination of programmed computer components and custom hardware components. In one embodiment, one or more components of computer system 500, or other components, which may be integrated into one or more components of computer system 500, contain hardwired logic for performing the operations of flowcharts in FIGS. 6-8.

In one embodiment, computer system 500 includes multiple peripheral components that facilitate input and output. These peripheral components are connected to multiple controllers, adapters, and expansion slots, such as input/output (I/O) interface 526, coupled to one of the multiple levels of bus 522. For example, input device 524 includes, for example, a microphone, a video capture device, an image scanning system, a keyboard, a mouse, or other input peripheral device, communicatively enabled on bus 522 via I/O interface 526 controlling inputs. In addition, for example, output device 520 communicatively enabled on bus 522 via I/O interface 526 for controlling outputs include, for example, one or more graphical display devices, audio speakers, and tactile detectable output interfaces, but in another example also includes other output interfaces. In alternate embodiments of the present invention, additional or alternate input and output peripheral components may be added.

With respect to FIG. 5, the one or more embodiments present invention including, but are not limited to, a system, a method, and/or a computer program product. In one embodiment, the computer program product includes a computer readable storage medium (or media) having computer readable program instructions thereon for causing a processor to carry out aspects of the present invention.

In one embodiment, the computer readable storage medium is a tangible device that can retain and store instructions for use by an instruction execution device. The computer readable storage medium includes, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. In one embodiment, the network comprises copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

In one embodiment, computer readable program instructions for carrying out operations of the present invention include one or more of assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. In one embodiment, the computer readable program instructions execute entirely on the user's computer, partly on the user's computer, as a stand-alone software package, partly on the user's computer and partly on a remote computer or entirely on the remote computer or server. In the latter scenario, in one example, the remote computer is connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Those of ordinary skill in the art will appreciate that in additional or alternate embodiments, the hardware depicted in FIG. 5 may vary. Furthermore, those of ordinary skill in the art will appreciate that the depicted example is not meant to imply architectural limitations with respect to the present invention.

FIG. 6 illustrates a high level logic flowchart of a process and computer program for generating a partitioning policy, applied in a dialog system for partitioning multi-intent user input, generated from training data, which is also used to train a classifier for the dialog system.

In one example, a process and computer program starts at block 600 and thereafter proceeds to block 602. Block 602 illustrates applying training data to train an input classifier system for classifying user input to a dialog system. Next, block 604 illustrates deriving a partitioning policy for partitioning segments of multi-intent user input based on at least one characteristic of the training data, and the process ends.

FIG. 7 illustrates a high level logic flowchart of a process and computer program for specifying a response strategy for managing responses to multi-intent user input to a dialog system.

In one example a process and computer program starts at block 700 and thereafter proceeds to block 702. Block 702 illustrates establishing a dialog management method for selecting an output in response to an identified intent class identified in a user input. Next, block 704 illustrates determining a response strategy from the dialog management method for responding to multi-intent inputs with multiple classes, and the process ends.

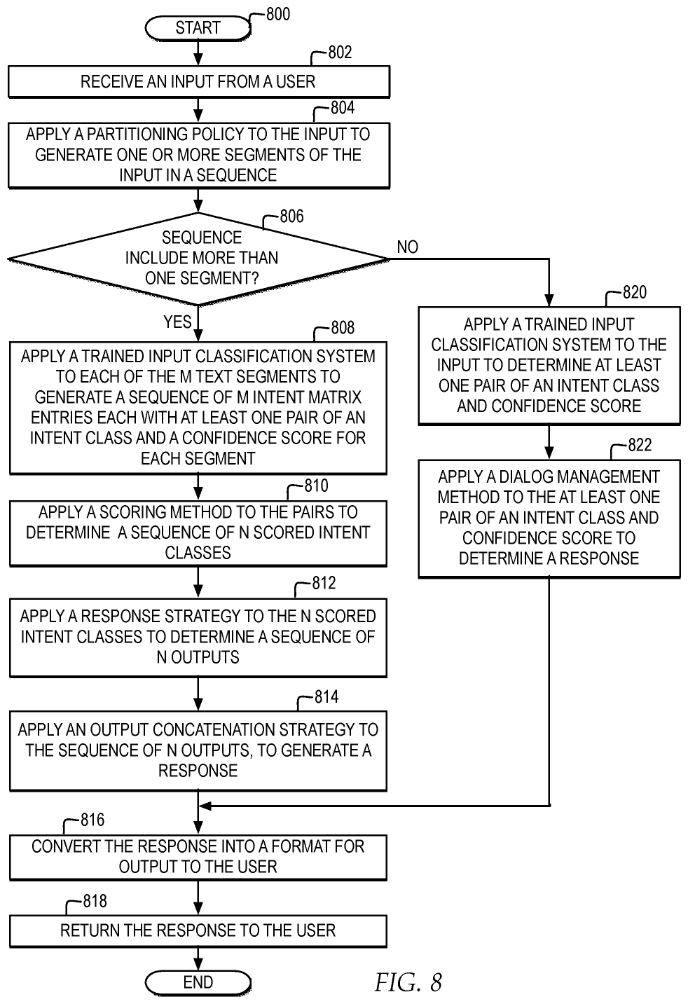

FIG. 8 illustrates a high level logic flowchart of a process and computer program for managing a response to a multi-intent user input by a classifier-based dialog system.

In one example, a process and computer program starts at block 800 and thereafter proceeds to block 802. Block 802 illustrates applying a partitioning policy to the input to generate one or more segments of the input in a sequence. Next, block 804 illustrates a determination whether a sequence includes more than one segment.

At block 804, if the sequence does not include more than one segment, then the process passes to block 820. Block 820 illustrates applying a trained input classification system to the input to determine at least one pair of an intent class and confidence score for the input. Next, block 822 illustrates applying a dialog management method to the at least one pair of an intent class and confidence score to determine a response to a most likely intent class, and the process passes to block 816.

At block 804, if the sequence includes more than one segment, then the process passes to block 808. Block 808 illustrates applying a trained input classification system to each of the ‘m’ text segments to generate a sequence of ‘m’ intent matrix entries each with at least one pair of an intent class and a confidence score for each segment. Next, block 810 illustrates applying a scoring method to the pairs to determine a sequence of ‘n’ scored intent classes. Thereafter, block 812 illustrates applying a response strategy to the ‘n’ scored intent classes to determine a sequence of ‘n’ outputs corresponding to the ‘n’ scored intent classes. Next, block 814 illustrates applying an output concatenation strategy to the sequence of ‘n’ outputs to generate a response. Thereafter, block 816 illustrates converting the response into a format for output to the user. Next, block 818 illustrates returning the response to the user, and the process ends.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, occur substantially concurrently, or the blocks may sometimes occur in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification specify the presence of stated features, integers, steps, operations, elements, and/or components, but not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the one or more embodiments of the invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described to best explain the principles of the invention and the practical application, and to enable others of ordinary skill in the art to understand the invention for various embodiments with various modifications as are suited to the particular use contemplated.

The foregoing description is just an example of embodiments of the invention, and variations and substitutions. While the invention has been particularly shown and described with reference to one or more embodiments, it will be understood by those skilled in the art that various changes in form and detail may be made therein without departing from the spirit and scope of the invention.

What is claimed is:

1. A method comprising:
receiving, by a computer, a multi-intent input from a user, wherein the multi-intent input comprises a selection of a plurality of intents in a single conversational input;
splitting, by the computer, the multi-intent input into a plurality of segments, wherein each of the segments comprises a subsequence of the multi-intent input;
applying, by the computer, a classifier to classify each segment of the plurality of segments by at least one pair of a plurality of pairs in a matrix, each pair of a separate class of a plurality of classes and a separate confidence level of classification, each of the plurality of classes associated with a separate intent from among the plurality of intents;
selecting, by the computer, one or more outputs for each separate class in each separate pair, in view of the separate confidence level; and
outputting, by the computer, a response comprising a concatenation of the one or more outputs to the user.

2. The method according to claim 1, wherein receiving, by a computer, a multi-intent input from a user, wherein the multi-intent input comprises a selection of a plurality of intents in a single conversational input further comprises:
receiving, by the computer, the multi-part input from the user at a classifier-based dialog system for receiving the multi-part input and returning the response comprising a single communication in response to the multi-intent input.

3. The method according to claim 1, wherein splitting, by the computer, the multi-intent input into a plurality of segments, wherein each of the segments comprises a subsequence of the multi-intent input further comprises:
applying, by the computer, a partitioning policy to the multi-part input to identify the plurality of segments, the partitioning policy identifying at least one type of characteristic of a corpus of data used to train the classifier.

4. The method according to claim 1, wherein selecting, by the computer, one or more outputs for each separate class, in view of the separate confidence level further comprises:
aggregating, by the computer, a first confidence score assigned in a first pair of the plurality of pairs for a first class with a second confidence score assigned in a second pair of the plurality of pairs for the first class.

5. The method according to claim 1, wherein selecting, by the computer, one or more outputs for each separate class, in view of the separate confidence level further comprises:
applying, by the computer, a scoring method to the plurality of pairs to determine a ranked selection of classes of the plurality of classes from among the plurality of pairs; and
applying, by the computer, a response strategy to the ranked selection of classes to determine a sequence of the one or more outputs.

6. The method according to claim 1, further comprising:
concatenating, by the computer, the one or more outputs to generate the response by applying a concatenation strategy to select an order of the one or more outputs.

7. The method according to claim 1, further comprising:
responsive to splitting, by the computer, the multi-intent input from the user into a single segment, applying the classifier to classify the single segment by a single pair of a single class and a single confidence score;
selecting, by the computer, the one or more outputs comprising a single output for the single class in view of the single confidence level; and
outputting, by the computer, the response comprising the single output to the user.

8. A computer system comprising one or more processors, one or more computer-readable memories, one or more computer-readable storage devices, and program instructions, stored on at least one of the one or more storage devices for execution by at least one of the one or more processors via at least one of the one or more memories, the stored program instructions comprising:
program instructions to receive a multi-intent input from a user, wherein the multi-intent input comprises a selection of a plurality of intents in a single conversational input;
program instructions to split the multi-intent input into a plurality of segments, wherein each of the segments comprises a subsequence of the multi-intent input;
program instructions to apply a classifier to classify each segment of the plurality of segments by at least one pair of a plurality of pairs in a matrix, each pair of a separate class of a plurality of classes and a separate confidence level of classification, each of the plurality of classes associated with a separate intent from among the plurality of intents;
program instructions to select one or more outputs for each separate class in each separate pair, in view of the separate confidence level; and
program instructions to output a response comprising a concatenation of the one or more outputs to the user.

9. The computer system according to claim 8, wherein program instructions to receive a multi-intent input from a user, wherein the multi-intent input comprises a selection of a plurality of intents in a single conversational input further comprise:
program instructions to receive the multi-part input from the user at a classifier- based dialog system for receiving the multi-part input and returning the response comprising a single communication in response to the multi-intent input.

10. The computer system according to claim 8, wherein program instructions to split the multi-intent input into a plurality of segments, wherein each of the segments comprises a subsequence of the multi-intent input further comprise:
program instructions to apply a partitioning policy to the multi-part input to identify the plurality of segments, the partitioning policy identifying at least one type of characteristic of a corpus of data used to train the classifier.

11. The computer system according to claim 8, wherein program instructions to select one or more outputs for each separate class, in view of the separate confidence level further comprise:
program instructions to aggregate a first confidence score assigned in a first pair of the plurality of pairs for a first class with a second confidence score assigned in a second pair of the plurality of pairs for the first class.

12. The computer system according to claim 8, wherein program instructions to select one or more outputs for each separate class, in view of the separate confidence level further comprise:
program instructions to apply a scoring method to the plurality of pairs to determine a ranked selection of classes of the plurality of classes from among the plurality of pairs; and
program instructions to apply a response strategy to the ranked selection of classes to determine a sequence of the one or more outputs.

13. The computer system according to claim 8, further comprising:
program instructions to concatenate the one or more outputs to generate the response by applying a concatenation strategy to select an order of the one or more outputs.

14. The computer system according to claim 8, further comprising:
program instructions, responsive to splitting the multi-intent input from the user into a single segment, to apply the classifier to classify the single segment by a single pair of a single class and a single confidence score;
program instructions to select the one or more outputs comprising a single output for the single class in view of the single confidence level; and
program instructions to output the response comprising the single output to the user.

15. A computer program product comprises a computer readable storage medium having program instructions embodied therewith, wherein the computer readable storage medium is not a transitory signal per se, the program instructions executable by a computer to cause the computer to:
receive, by a computer, a multi-intent input from a user, wherein the multi-intent input comprises a selection of a plurality of intents in a single conversational input;
split, by the computer, the multi-intent input into a plurality of segments, wherein each of the segments comprises a subsequence of the multi-intent input;
apply, by the computer, a classifier to classify each segment of the plurality of segments by at least one pair of a plurality of pairs in a matrix, each pair of a separate class of a plurality of classes and a separate confidence level of classification, each of the plurality of classes associated with a separate intent from among the plurality of intents;
select, by the computer, one or more outputs for each separate class in each separate pair, in view of the separate confidence level; and
output, by the computer, a response comprising a concatenation of the one or more outputs to the user.

16. The computer program product according to claim 15, further comprising the program instructions executable by a computer to cause the computer to:
receive, by the computer, the multi-part input from the user at a classifier-based dialog system for receiving the multi-part input and returning the response comprising a single communication in response to the multi-intent input.

17. The computer program product according to claim 15, further comprising the program instructions executable by a computer to cause the computer to:
apply, by the computer, a partitioning policy to the multi-part input to identify the plurality of segments, the partitioning policy identifying at least one type of characteristic of a corpus of data used to train the classifier.

18. The computer program product according to claim 15, further comprising the program instructions executable by a computer to cause the computer to:
aggregate, by the computer, a first confidence score assigned in a first pair of the plurality of pairs for a first class with a second confidence score assigned in a second pair of the plurality of pairs for the first class.

19. The computer program product according to claim 15, further comprising the program instructions executable by a computer to cause the computer to:
apply, by the computer, a scoring method to the plurality of pairs to determine a ranked selection of classes of the plurality of classes from among the plurality of pairs; and
apply, by the computer, a response strategy to the ranked selection of classes to determine a sequence of the one or more outputs.

20. The computer program product according to claim 15, further comprising the program instructions executable by a computer to cause the computer to:
concatenate, by the computer, the one or more outputs to generate the response by applying a concatenation strategy to select an order of the one or more outputs.
